(19) United States
(12) Patent Application Publication
(10) Pub. No.: US 2006/0181142 A1
(43) Pub. Date: Aug. 17, 2006

(54) Pneumatically controlled load compensating brake system

(76) Inventor: Joseph Hettinger, Aurora, IL (US)

Correspondence Address: Mircea A. Tipescu;BRINKS HOFER GILSON & LIONE, POST OFFICE BOX 10395, CHICAGO, IL, 60610, US

(21) Appl. No.: 11/323,367

(22) Filed: Dec. 29, 2005

Related U.S. Application Data
(60) Provisional application No. 60/640,561, filed on Dec. 30, 2004.

(51) Int. Cl. B60T 8/18

(52) U.S. Cl. 303/22.7

(57) ABSTRACT

A pneumatically controlled load compensating brake system for a wheel truck is provided. The wheel truck includes a bolster resiliently supported on a pair of side frames mounted on a spaced pair of axles having wheels at each end. The brake system includes a pair of brake beams extending across the wheel truck adjacent the axles with brake shoes at each end for engaging the wheels. An expandable pneumatic means is supported on the bolster and is inter-connected to the brake beams by a multiple lever system. The lever system is operable to move the beams relative to each other to press the brake shoes against the wheels upon pressurization of the expandable pneumatic means by an empty and load valve. The empty and load valve senses a change in load on the bolster and is operable to change pressure to the pneumatic means in response thereto.

### RELATED APPLICATION

This application claims the benefit pursuant to 35 U.S.C. §119(e) of Provisional U.S. Patent Application Ser. No. 60/640,561 filed on Dec. 30, 2003, which is expressly incorporated herein by reference.

### BACKGROUND

1. Technical Field

This invention relates, in general, to railroad car brake systems and, more particularly, to a truck-mounted brake system which is load sensitive and uses a pneumatically controlled air bag to compensate for different weight loads.

2. Background Information

Brake systems for double axle wheel trucks generally include brake shoes mounted on opposite ends of a pair of brake beams which are positioned between the axles, the beams being movable away from each other to press the shoes into engagement with the wheels. Customarily, these brake systems include a cylinder and piston for actuating the brake shoes into frictional engagement with the wheels. The cylinder and piston can either be mounted on the railroad car which the wheel truck supports, “car mounted,” or can be mounted on the wheel truck, “truck mounted.” In both cases, a multiple lever system interconnects the piston and the brake beams for operation of the brakes.

One of the problems arising in all railroad car brake systems is that the load imposed by the cars on their respective wheel trucks can vary considerably from car to car. Thus, in a single train, some cars may be fully loaded, some partially loaded, and some empty. Consequently, if uniform pressure is applied to the pneumatic means, i.e., the piston/cylinder, for the wheels of all the cars, the braking effect will be much higher on partially loaded and empty cars than on fully loaded cars and is undesirable.

U.S. Pat. No. 4,775,035, issued Oct. 4, 1988, which is expressly incorporated herein by reference, discloses a wheel truck mounted brake system with pneumatic means operable through multiple levers to move the brake beams relative to each other. The lever system includes a double acting slack adjuster responsive to load changes to vary the braking force. Different load weights on the truck bolster causes it to assume different vertical positions relative to the side frames and the slack adjuster to vary in length so that uniform pressure to the pneumatic means produces higher brake pressure to the wheels of fully loaded cars and lower brake pressures to partially loaded and unloaded cars.

The present invention is also directed to a simple, light weight truck mounted brake system for wheel trucks which automatically compensates for different loads imposed on the trucks, and which provides for uniform braking for different loaded cars. The brake system of this invention uses standard truck components and brake beams and includes an empty and load valve to vary the pressure to a pneumatic means to compensate for load changes.

### BRIEF SUMMARY

In one aspect of the invention, a pneumatically controlled load compensating brake system for a wheel truck is provided. The wheel truck includes a bolster resiliently supported on a pair of side frames that are mounted on a spaced pair of axles having wheels at each end. The brake system includes a pair of brake beams extending across the wheel truck adjacent respective ones of the axles with brake shoes at each end for engaging the wheels. An expandable pneumatic means is supported on the bolster and is inter-connected to the brake beams by a multiple lever system. The lever system is operable to move the beams relative to each other to press the brake shoes against the wheels upon pressurization of the expandable pneumatic means. The pneumatic means is connected to an empty and load valve which is responsive to the vertical position of the bolster relative to the side frames and is operable to change pressure to the pneumatic means upon a change in load on the bolster.

### BRIEF DESCRIPTION OF THE DRAWINGS

FIG. 1 is a top plan view of a double axle wheel truck incorporating the present invention;

FIG. 2 is a side elevational view of the structure of FIG. 1;

FIG. 3 is an enlarged sectional view of the structure of FIG. 1 taken along the line 3--3 thereof;

FIG. 4 is a perspective view of the structure of the brake system of this invention shown with the wheel truck structure removed for clarity;

FIG. 5 is an enlarged view of a portion of the structure of FIG. 4; and

FIG. 6 is an enlarged exploded view of a guide and follower structure according to one embodiment of the present invention.

### DETAILED DESCRIPTION OF THE DRAWINGS AND THE PRESENTLY PREFERRED EMBODIMENTS

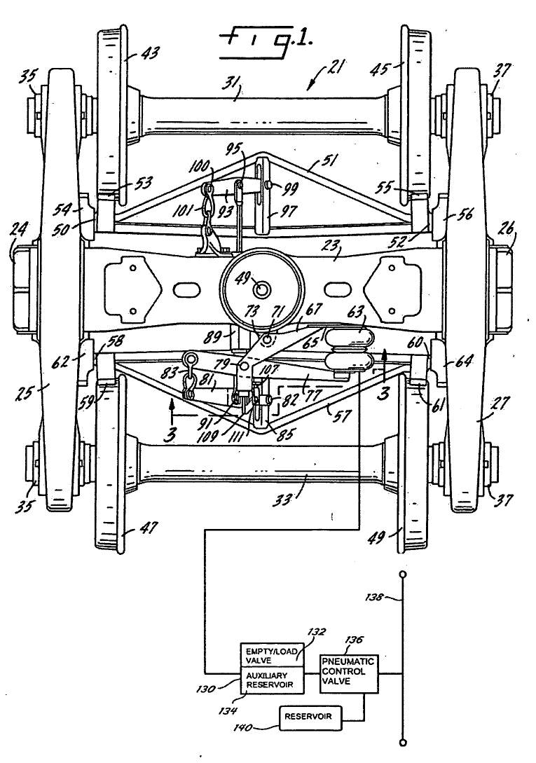

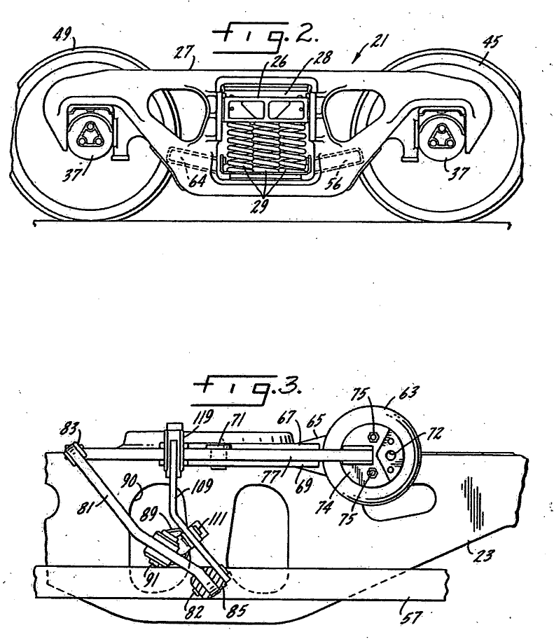

Referring now more specifically to the drawings, a wheel truck incorporating the brake system of the present invention is shown generally at 21 in FIGS. 1 and 2 and is seen to include a rigid bolster 23 having a snubber 24, 26 at each end thereof extending through vertically elongated openings 28 in a pair of side frames 25, 27, respectively. A plurality of truck springs 29 are disposed in each opening 28 beneath the snubbers 24, 26 and resiliently support the bolster 23 for vertical movement relative thereto. The “normal” unloaded position of the bolster 23 is as shown in FIG. 2.

The side frames 25, 27 are each supported at opposite ends on a pair of spaced, parallel axles 31, 33 by wheel bearing assemblies 35, 37, and wheels 43, 45 and 47, 49 are mounted on axles 31, 33, respectively, near opposite ends thereof. In use, one of the wheel trucks 21 supports each end of a railroad car (not shown), with the car mounted on and secured to the bolster 23. A centering pin 49 on the bolster 23 locates the car body thereon, as will be understood by those skilled in the art.

In accordance with the invention, a brake assembly is provided for the wheel truck 21, which brake assembly includes a pair of brake beams extending across the wheel truck adjacent respective ones of the axles with brake shoes at each end for engaging the wheels. As embodied herein, a brake beam 51 extends across the wheel truck 21 between the bolster 23 and the axle 31 and is provided with a pair of brake shoes 53, 55 at opposite ends thereof positioned to confront and engage the wheels 43, 45, respectively. Brake beam 51 is provided with a pair of projections 50, 52 which are slidably received in tracks 54, 56 formed in side frames 25, 27 (see FIGS. 1 and 2) so that the beam 51 is supported on the frames 25, 27.

Another brake beam 57 extends across the truck 21 between the bolster 23 and axle 33 and has a pair of brake shoes 59, 61 positioned to confront and engage the wheels 47, 49, respectively. Brake beam 57 also has a pair of projections 58, 60 which slide in tracks 62, 64 in side frames 25, 27. When the brake beams 51, 57 are moved away from each other, as allowed by the slidable projections and tracks, the brake shoes 53, 55 and 59, 61 engage the wheels 43, 45 and 47, 49, respectively. When the beams 51, 57 are moved toward each other, the brake shoes are released from the wheels.

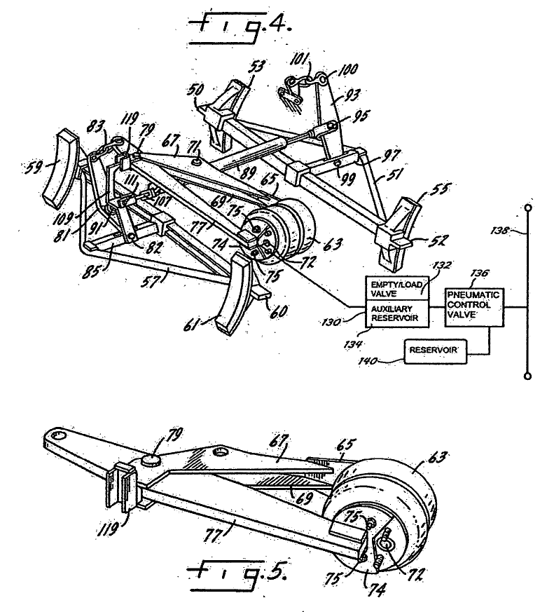

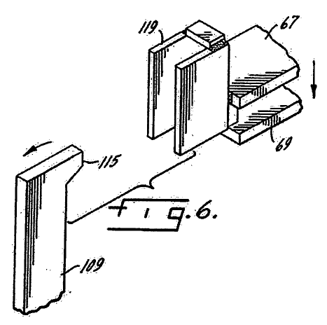

In accordance with the invention, pneumatic means is supported on the truck bolster and is operable under air pressure to cause the brake beams to move relative to each other and to press the brake shoes into engagement with the wheels. As embodied herein, an expandable air bag 63 has one end suitably fixed to a plate 65 rigid with a bracket formed by a pair of spaced, parallel plates 67, 69 (see FIGS. 4 and 5). The air bag 63 may be constructed as are those which are commercially available for use as air springs in tractor-trailers. A suitable air bag is a Firestone AIRSTROKE (registered trademark of Firestone Tire and Rubber Company) NO. 20 air mount, obtainable from Firestone Industrial Products Co., Noblesville, Ind. The air bag has a minimum or unpressurized “design” height of 3 inches and an applied height for a loaded car of 6⅞ inches to 7⅜ inches, i.e., the length of the air bag upon brake application when the car is loaded. At the applied height, the air bag output force was 1,600 pounds, when charged to 50 psig. (pounds per square inch gauge).

The bracket plates 67, 69 preferably are welded to the plate 65 so that the assembly is rigid. Importantly, the bracket plates 67, 69 and air bag 63 are supported upon the bolster 23 by a pivot pin 71 which extends through the bracket plates 67, 69 and through a bracket 73 rigid with the bolster 23. The bracket eye 73 is a standard item on conventional bolsters and is cast integral therewith.

Construction using air bags rather than conventional cast brake cylinders is considerably lighter in weight and easier to operate than conventional piston and cylinder devices which are conventionally cast iron. The bag 63 is provided with a fitting 72 adapted for connection to a compressed air source via an empty/load valve system 130 so that the bag 63 may be expanded to a desired pressure, as shown in FIG. 4. The normal or “design” configuration of the bag 63 is as shown in FIGS. 1, 4 and 5.

In accordance with the invention, a multiple lever system interconnects the pneumatic means and the brake beams and is operable to cause the brake beams to move relative to each other and the brake shoes to engage the wheels upon pressurization of the pneumatic means by the empty/load valve system.

As embodied herein, the end of the air bag 63 opposite the plate 65 is connected to another plate 74 by bolts 75. The plate 74 is rigidly fixed to one end of an actuator lever 77 which is pivotally connected at an intermediate point to the bracket plates 67, 69 by a pin 79. The actuator lever 77 has its other end connected to one end of a live lever 81 by a short chain or link 83. The other end of lever 81 is pivoted by a pin 82 to a center brace 85 of brake beam 57. An intermediate point of the live lever 81 is pivoted to one end of a slack adjuster 89 by a pin 91. The slack adjuster 89 extends through an openings 90 in the bolster 23 and its other end is pivoted to an intermediate point of a dead lever 93 by a pivot pin 95. The slack adjuster 89 normally acts as a rigid link or lever but is selectively variable in length, as is explained below. The lower end of dead lever 93 is pivoted by a pin 99 to a center brace 97 of the brake beam 51. The upper end of the dead lever 93 is fixed by a pin 100 to a short chain or link O10 which is also fixed to the bolster 23.

In use, the empty/load valve system 130 admits a desired amount of compressed air to the air bag 63 through fitting 72 causing the air bag to expand. When compressed air is admitted to the air bag 63, it expands causing the actuator lever 77 to pivot about pin 79 in a clockwise direction, as seen in FIG. 1. Air bag 63 is free floating in that it is attached only to levers 67, 69, 77, but reaction forces in the lever system normally hold plate 65 against the side of bolster 23, as shown in FIG. 1. If desired, plate 65 could be fixed to the bolster in this position.

Clockwise pivotal movement of actuator lever 77 causes live lever 81 to follow the actuator lever 77 which, through the slack adjuster 89 which is placed in compression between live lever 81 and dead lever 93 and the dead lever 93 moves the brake beam 51 toward the axle 31 and the shoes 53, 55 into engagement with the wheels 43, 45. Continued pivotal movement of the actuating lever 77 after brake shoes 53, 55 engage wheels 43, 45 causes a reaction force through slack adjuster 89 and presses the brake shoes 59, 61 into engagement with the wheels 47, 49. When the compressed air to air bag 63 is released, it contracts to its design shape and the brake shoes 53, 55 and 59, 61 are released from the wheels.

In accordance with the invention, the empty/load valve system 130 senses load conditions upon the car and is operable to control the pressure to the air bag 63, and thus the brake pressure to the wheels, in response thereto. It will be appreciated that the empty/load valve system 130 also is adapted for connection to the compressed air system of the railroad car with which the wheel truck 21 is used, as shown in FIGS. 1 and 4.

An empty/load valve system 130 typically includes an empty/oad valve 132 and an auxiliary reservoir 134. A suitable empty/load valve is a SC-1™ Empty and Load Valve manufactured by Wabtec Corp., Wilmerding, Pa. Other suitable valves include a Empty/Load Remote Proportioning (ELRP) system manufactured by New York Air Brake Corp., Watertown, N.Y., and a Model 6600-1 Empty/Load Device manufactured by Ellcon-National, Inc., Greenville, S.C.

As embodied herein, the empty/load valve 132 includes a sensor valve (not shown) and a proportioning valve (not shown). A sensor valve may use a diaphragm to detect pressure exerted by the bolster 23 corresponding to load conditions upon the car and has least two positions, e.g., empty and load positions. The proportioning valve is capable of proportioning the pressure to the air bag 63 by diverting a predetermined amount of the air supplied to the empty/load valve 132 to the auxiliary reservoir 134. For example, in the loaded position, the proportioning valve directs all of the air supplied to the empty/load valve 132 to the air bag 63. In the empty position, the proportioning valve diverts a predetermined amount of the air supply (the proportioning level) to the auxiliary reservoir 134, and thus proportions the pressure to the air bag 63. As a result, the valve applies a greater pneumatic pressure to the air bag 63 in the loaded position than in the empty position.

Thus, as the bolster 23 moves downwardly relative to the side frames 25, 27, indicating a heavy load in the car (not shown) which is supported on the bolster 23, the sensor valve causes the empty/load valve system 130 to change from an empty to a loaded position. This causes a greater pneumatic pressure to be applied to the air bag 63, which causes the brake shoes to exert a greater braking pressure to the wheels. Thus, the braking effect on the wheel trucks for a loaded car is increased. When the bolster 23 moves upwardly relative to side frames 25, 27, indicating a lighter load in the car, the empty/load valve system 130 is in the empty position and the empty/load valve 132 applies lesser pneumatic pressure to the air bag 63. Thus, less braking pressure is applied to the wheels so that the braking effect on the wheel trucks for a partially loaded or empty car is less.

In this way, the empty/load valve system 130 recognizes a load condition upon the car body and adjusts the available braking force in response thereto. Thus, the braking effect on each wheel truck is adjusted and controlled to compensate for variations in the load on that wheel truck so that the braking effect can be uniform on each of the trucks of a multiple car train.

As can be appreciated, the range of load and no-load braking will vary depending on the proportioning level of the empty/load valve. It is contemplated that the braking forces exerted by the brake shoes upon the wheels of a truck of an unloaded car should be 40% to 80% of the fully-loaded braking force. Any such desired range can be achieved through the calibration of the proportioning level of the empty/load valve.

It will be understood by those skilled in the art that the compressed air supply of the train may be used to control the empty/load valve system 130 using a standard pneumatic control valve 136. A suitable control valve is an ABDX™ freight brake control valve manufactured by Wabtec Corp. The control valve monitors the pressure in a brake pipe 138 which carries the compressed air supply of the train. The control valve 136 is connected to the empty/load valve system 130 and a reservoir 140 which is pressurized from the brake pipe. The control valve 136 selectively communicates pressurized air from the reservoir 140 to the empty/load valve system 130 in order to control the air pressure in the air bag 63.

In accordance with the invention, the lever system includes a double acting slack adjusted operable to increase and decrease in length to change the travel of the beams required for engagement of the shoes with the wheels.

As embodied herein and described above, the live lever 81 and the dead lever 93 are interconnected by slack adjuster 89. Normally, the slack adjuster 89 acts as a rigid compression link and transmits motion of the lever 81 directly to the lever 93. However, the slack adjuster 89 is, in addition, a double acting device which is operable to elongate and contract in length in response to external input. In accordance with the invention, such input derives from normal brake shoe wear and consequent brake shoe replacement.

A trigger rod 107 is movable longitudinally relative to the adjuster 89 to release an internal holding mechanism such as a pawl (not shown) and allows an internal torsion spring mechanism (not shown) to turn a nut (not shown) which lengthens or shortens the slack adjuster. As will be understood by those skilled in the art, the “double acting” adjuster used herein has a double acting pawl and torsion spring assembly including a reversible nut, one pawl of which is released from the nut allowing one torsion spring to turn it in one direction to cause elongation, and the other pawl of which is released from the nut allowing another torsion spring to turn it in the other direction to cause contraction.

Examples of double acting slack adjusters are found, for example, in United States patents issued to H. R. Billeter and assigned to Sloan Valve Company, Chicago, Ill. Such examples are U.S. Pat. No. 3,454,140 issued Jul. 8, 1969, U.S. Pat. No. 3,595,347 issued Jul. 27, 1971, U.S. Pat. No. 3,602,343 issued Aug. 31, 1971, and U.S. Pat. No. 3,669,224 issued Jun. 13, 1972.

A suitable double acting slack adjuster is Model No. 7100-21 manufactured by Ellcon-National of Greenville, S.C. In that device, movement of trigger rod 107 in an downward direction relative to the adjuster 87, as seen in FIG. 1 (in a left-hand direction as seen in FIG. 4), causes the adjuster 89 to elongate. Opposite directional movement of trigger rod 107 causes the adjuster to contract.

The trigger rod 107 is pivoted at one end to an intermediate point of a trigger lever 109 by a pivot pin 111. The lower end of the trigger lever 109 is pinned to the beam brace 85 and to live lever 81 by pin 82. The upper end of trigger lever 109 is formed with a shoe 115 which is held in engagement with a guide 119, such as a channel or angle, suitably fixed as by welding to bracket plates 67, 69. This arrangement provides slack for the brake assembly under varying load changes.

Thus, as the bolster 23 moves downwardly relative to the side frames 25, 27, indicating a heavy load in the car (not shown) which is supported on the bolster 23, the guide 119 also moves downwardly. Since the trigger lever 109 is pinned to the beam brace 85 and the beam 57 is slidably guided in tracks 62, 64 on side frames 25, 27, the lever 109 does not move with the bolster 23 and the guide 119 moves downwardly relative to shoe 115.

As noted above, the slack adjuster 89 takes up slack in the lever system as the brake shoes wear. Thus, when pressure is applied to expand the air bag 63, the brake beams 51, 57 move away from each other until the brake shoes 53, 55 and 59, 61 engage the wheels. As the brake shoes wear, the travel of the beams 51, 57 increases and causes the trigger lever 109 to pull the trigger rod 107 toward the left, as seen in FIG. 4. As can be appreciated, this produces a lengthening of the slack adjuster 89 which compensates for brake shoe wear. Specifically, once the slack adjuster 89 is lengthened, less travel (expansion) is required to apply the brake shoes to the wheels when a pneumatic pressure is applied to the air bag 63.

The dimensions and shape of the parts including the length of the trigger lever 109, and the position of the pivot pin 111 on the lever 109 are selected to proportion the amount of length adjustment of slack adjuster 89 to the amount of brake shoe wear and to provide the desired adjustment in braking effect in accordance with brake shoe wear. Thus, by this invention, the braking effect on each wheel truck is adjusted and controlled to compensate for break shoe wear so that the braking effect can be uniform over the life of the brake shoes.

It will be appreciated that other means for attaching the trigger rod 107 to the lever assembly could be used which compensates for brake shoe wear. For example, according to another embodiment, the trigger rod 107 could be pivoted by a pin to an intermediate point of the live lever 81. One end of the slack adjuster 89 is also pivoted to an intermediate point of the live lever 81 by a pin 91 the same as trigger rod 107. Thus, increased travel of the brake beams 51, 57, 69, indicating brake shoe wear, produces a lengthening of the slack adjuster 89.

As described above, the bolster 23 is of standard construction and has the air bag 63 and the multiple lever system supported thereon with no modifications to the bolster, using the provided bracket eye 73. Similarly, the brake beams 51, 57 are standard and require no modifications since the trigger lever 109 is attached to the beam brace 85 using the same pivot 82 as the live lever 81.

By the foregoing, there has been disclosed a load compensating brake system for railroad car wheel trucks calculated to fulfill the inventive objects set forth herein. It will be understood that various additions, substitutions, modifications and omissions may be made to the present invention without departing from the scope or spirit of the invention. It is therefore intended that the foregoing detailed description be regarded as illustrative rather than limiting, and that it be understood that it is the following claims, including all equivalents, that are intended to define the spirit and scope of this invention.

I claim:

1. A pneumatically controlled load compensating brake system for a wheel truck which includes a bolster resiliently supported on a pair of side frames, said frames being mounted on a spaced pair of axles having wheels at each end, said brake system comprising:
a pair of brake beams extending across the wheel truck adjacent respective ones of the axles with brake shoes at each end for engaging the wheels,
expandable pneumatic means supported on said bolster,
a multiple lever system inter-connecting said expandable pneumatic means and said brake beams and operable to move said beams relative to each other to press said brake shoes against said wheels upon pressurization of said expandable pneumatic means, and
an empty and load valve responsive to the vertical position of said bolster relative to said side frames connected to said pneumatic means, wherein said empty and load valve is operable to change pressure to said pneumatic means upon a change in load on said bolster.

2. The brake system as claimed in claim 1, said brake beams being located between said bolster and respective ones of said axles and being movable away from each other to cause said shoes to engage said wheels.

3. The brake system as claimed in claim 2, said lever system including a double acting slack adjuster having a trigger rod, the slack adjuster being operable under control of the trigger rod to increase and decrease in length to change the travel of said beams required for engagement of said shoes with said wheels, and a pair of levers each connected at one end to a respective one of said brake beams, said slack adjuster connected at opposite ends to said levers, whereby elongation of said slack adjuster decreases the travel of said beams required to cause engagement of said brake shoes with said wheels.

4. The brake system as claimed in claim 1 wherein said expandable pneumatic means is an expandable air bag.

5. The brake system as claimed in claim 1, said lever system including:
a double acting slack adjuster having a trigger rod, the slack adjuster being operable under control of the trigger rod to increase and decrease in length to change the travel of said beams required for engagement of said shoes with said wheels,
a live lever having an end connected to one of said brake beams and an opposite end operatively connected to said expandable pneumatic means, and
a dead lever having an end connected to the other of said brake beams and an opposite end connected to said bolster,
wherein said double acting slack adjuster is connected at opposite ends thereof to said live lever and said dead lever intermediate the ends of said live and dead levers.

6. The brake system as claimed in claim 5 further comprising a bracket pivotally supported upon said bolster and supporting said expandable pneumatic means, said bracket defining a pivot point, wherein said connection between said live lever and said expandable pneumatic means includes an actuating lever pivotally supported by said bracket at said pivot point, said actuating lever having an end connected to said live lever and an opposite end connected to said expandable pneumatic means.

7. The brake system as claimed in claim 6 further comprising a trigger lever having an end operatively connected to said pivot point of said bracket and an opposite end connected to one of said brake beams, wherein said trigger rod is connected intermediate the ends of said trigger lever.

8. The brake system claimed in claim 7, said end of said trigger lever operatively connected to said pivot point forming a shoe, said shoe being received by a guide defining a vertical surface and supported upon said bracket at said pivot point, wherein said shoe is displaced in said guide in response to change in vertical position of said bolster relative to said side frames.

9. The load compensating brake system as claimed in claim 8 wherein said expandable pneumatic means is an expandable air bag.

10. The brake system claimed in claim 1, said brake beams being guidably supported on said side frames for movement toward and away from said axles.

11. The brake system claimed in claim 1, said pneumatic means including an expandable air bag connected at one end to a bracket pivotably supported on said bolster.

12. The brake system claimed in claim 11, the other end of said air bag being connected to an actuating lever pivoted on said bracket.
